(19) United States
(12) Patent Application Publication
(10) Pub. No.: US 2015/0336296 A1
(43) Pub. Date: Nov. 26, 2015

(54) MOLDING APPARATUS AND MOLDING METHOD

(71) Applicant: Toshiba Kikai Kabushiki Kaisha, Tokyo (JP)

(72) Inventors: Satoru AIDA, Tokyo (JP); Yuji ABE, Fujisawa-shi (JP); Hiroki AMEZAWA, Yokohama-shi (JP)

(21) Appl. No.: 14/717,767

(22) Filed: May 20, 2015

(30) Foreign Application Priority Data
May 21, 2014 (JP) 2014-105171

(51) Int. Cl. B29C 33/10

(52) U.S. Cl. CPC B29C 33/10

(57) ABSTRACT

A die cast machine which has a mold opening and closing device having a die plate driving device which drives a movable die plate holding a moving mold, a spray device having a head driving device which advances and retracts a spray head to and from a space between a fixed mold and a moving mold, and a control device which controls the spray device and a mold opening and closing device so as to make the movable die plate move in a mold opening-closing direction during a spray process of ejecting a mold releasing agent from the spray head or during an air blowing process of ejecting air from the spray head.

### TECHNICAL FIELD

The present invention relates to a molding machine (molding apparatus) and molding method. The molding machine is for example a die cast machine or injection molding machine.

### BACKGROUND ART

In a molding machine, for the purpose of suitably taking out a molded article which is formed by solidification of a molding material in a mold from the mold or another purpose, a mold releasing agent is coated on an inner surface of the mold before injecting the molding material into the mold.

Specifically, for example, a die cast machine in Patent Literature 1 opens a fixed die and a moving die, makes a spray head move to a space between the dies by a robot arm in that state, and sprays a mold releasing agent and air toward the inner surfaces of the fixed die and moving die from the spray head. When providing a robot arm as in Patent Literature 1, it is possible to position the spray head at any position, so the mold releasing agent can be suitably coated in accordance with various die shapes.

Further, in Patent Literature 2, considering the increase of cost when providing a robot arm and so on, movement of a movable die plate which holds a moving die is utilized for positioning the spray head and moving die. Specifically, in Patent Literature 2, before spraying the mold releasing agent, the movable die plate is moved in a closing direction and positioning of the moving die relative to the spray head is carried out so that a distance between the moving die and the spray head becomes a spraying distance which is determined in advance. With this art, the spraying distance can be adjusted in accordance with the thicknesses of various dies. Further, as a driving device for this purpose, the driving device for opening and closing the die is utilized, therefore the configuration is simplified.

### CITATIONS LIST

### Patent Literature

Patent Literature 1: Japanese Patent Publication No. 09-182946A

Patent Literature 2: Japanese Patent Publication No. 2007-167922A

### SUMMARY OF INVENTION

### Technical Problem

In the art of Patent Literature 1, as pointed out in Patent Literature 2 as well, the cost becomes high due to the provision of a robot arm. Further, in the art of Patent Literature 2, although the spraying distance can be adjusted in accordance with thicknesses of various dies with a simple configuration, adjustment in accordance with the die shape is not possible. As a result, in the art of Patent Literature 2, for example, according to the shape of the die, it is liable to occur that a mold releasing agent ends up being insufficient or excessive on a portion of the die.

Accordingly, it is desired to provide a molding apparatus and molding method which are capable of suitably spraying an ejected object (for example, a mold releasing agent or air) in accordance with the shapes of various molds with a simple configuration.

### Solution to Problem

A molding apparatus according to one aspect of the present invention has a mold opening and closing device having a fixed die plate which holds a fixed mold, a movable die plate which holds a moving mold, and a die plate driving device which makes the movable die plate move in a mold opening-closing direction; an ejection device having a feed device which feeds an ejected object to an eject head, and a head driving device which makes the eject head advance to and retract from a space between the fixed mold and the moving mold; and a control device which controls the ejection device and the mold opening and closing device so as to make the movable die plate move in the mold opening-closing direction during an injection process of ejecting the ejected object from the eject head.

A molding apparatus according to one aspect of the present invention has a mold opening and closing device having a fixed die plate which holds a fixed mold, a movable die plate which holds a moving mold, and a die plate driving device which makes the movable die plate move in a mold opening-closing direction; an ejection device having a feed device which feeds an ejected object to an eject head, and a head driving device which makes the eject head advance to and retract from a space between the fixed mold and the moving mold; and an input device which receives at least one input among a movement distance, movement speed, and movement pattern which are ones of the movable die plate in the mold opening-closing direction during the ejection process of ejecting the ejected object from the eject head.

A molding method according to one aspect of the present invention has an ejection process of ejecting an ejected object from an eject head which is positioned between a fixed die plate and a movable die plate, and a movement process of making the movable die plate which holds the moving mold move in the mold opening-closing direction during the ejection process.

### Advantageous Effects of Invention

According to the above configuration, the ejected object can be suitably sprayed in accordance with various die shapes with a simple configuration.

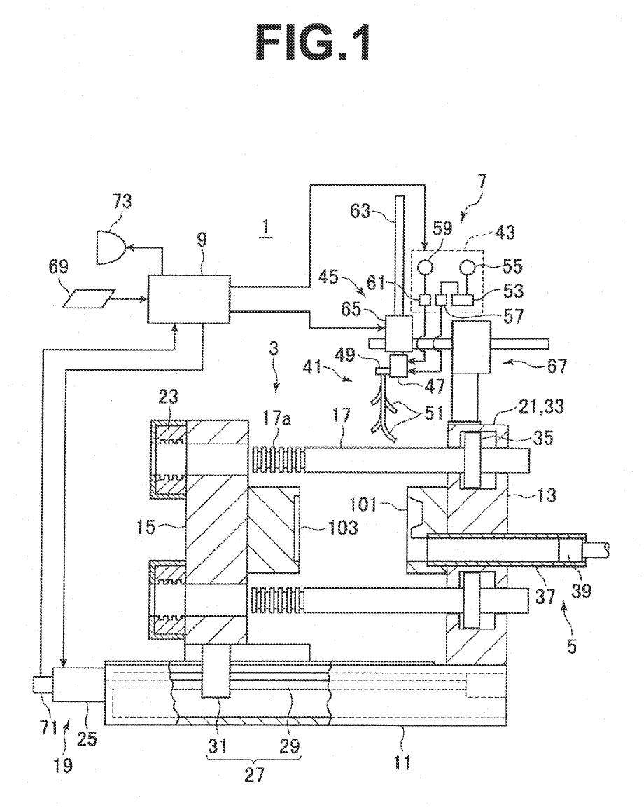

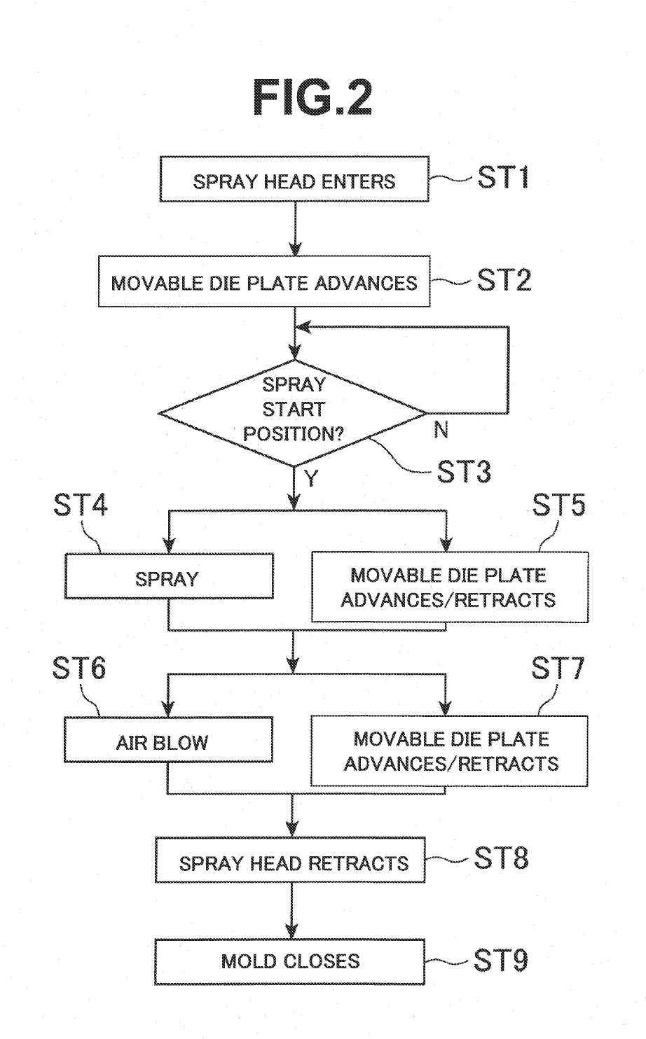

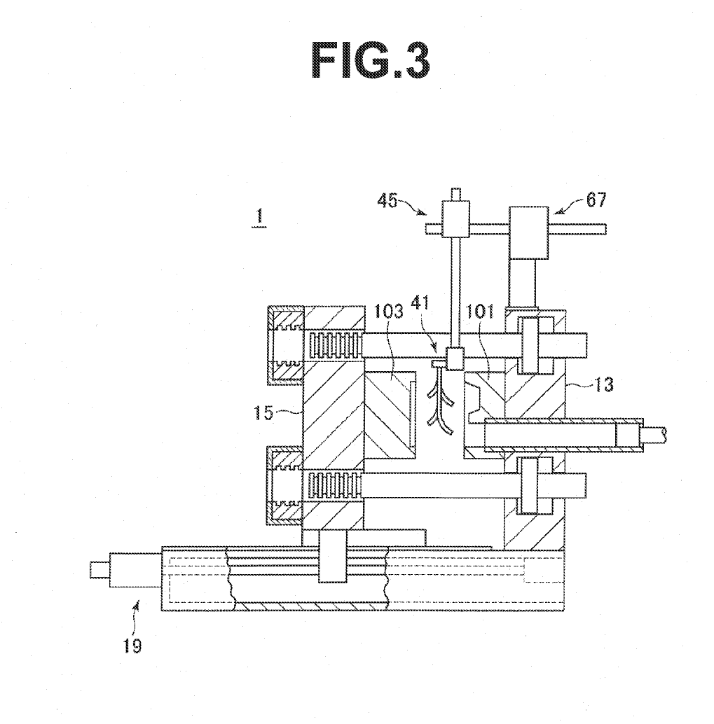

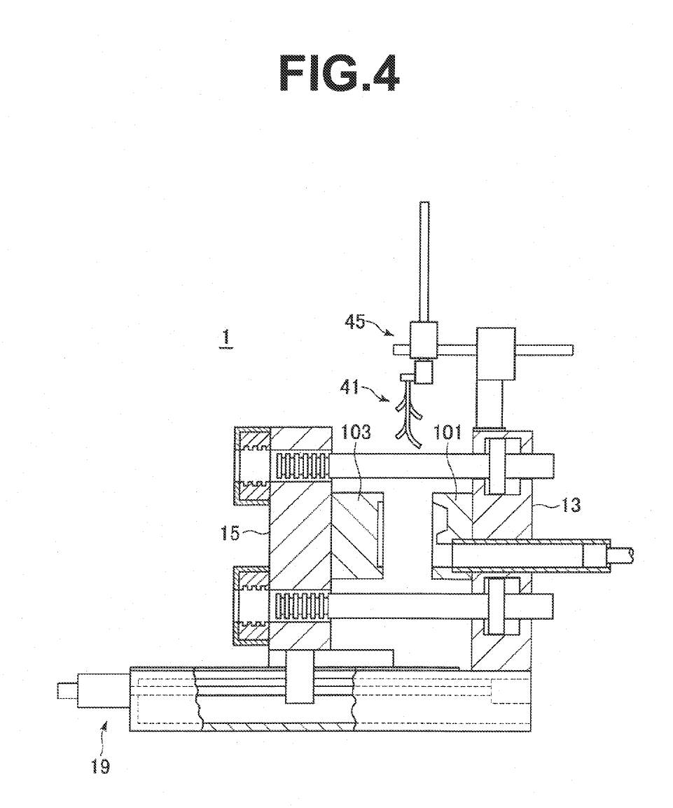

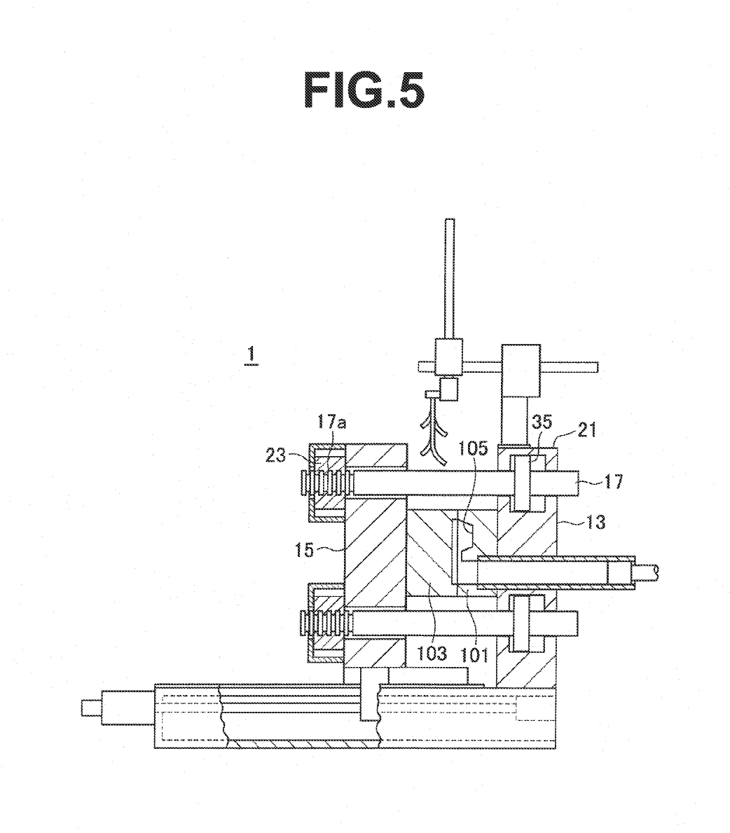

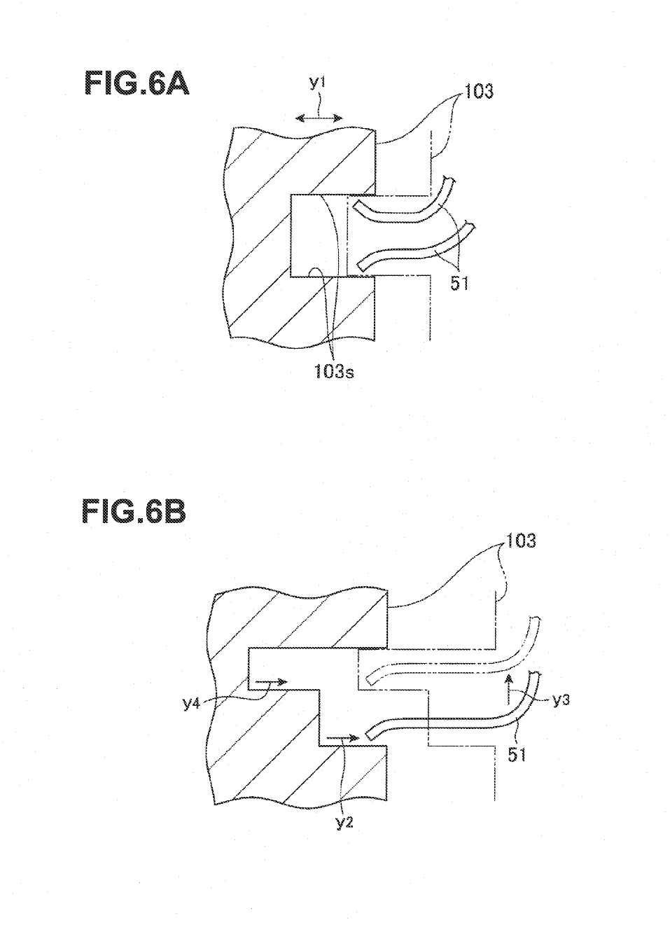

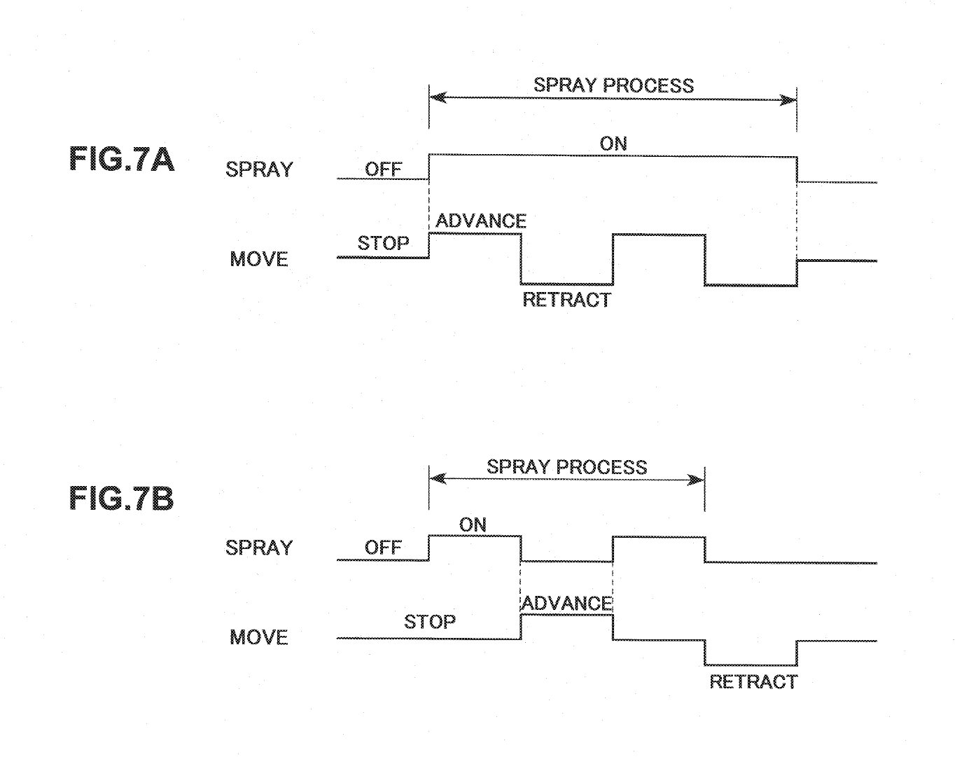

### BRIEF DESCRIPTION OF DRAWINGS

[FIG. 1] A schematic diagram showing the configuration of principal parts of a die cast machine according to an embodiment of the present invention in an opened state.

[FIG. 2] A flow chart showing the procedure of a portion of a molding cycle in the die cast machine in FIG. 1.

[FIG. 3] A schematic diagram showing a state at the time of start of the spray process of the die cast machine in FIG. 1.

[FIG. 4] A schematic diagram showing a state at the time of start of the mold closing process of the die cast machine in FIG. 1.

[FIG. 5] A schematic diagram showing a state at the time of start of the mold clamping operation in a mold clamping process of the die cast machine in FIG. 1.

[FIG. 6] FIG. 6A and FIG. 6B are schematic diagrams showing an example of relative movement of nozzles and a moving mold during the spray process.

[FIG. 7] FIG. 7A and FIG. 7B are schematic diagrams showing an example of timing of spraying and the movement of the moving mold during the spray process.

### DESCRIPTION OF EMBODIMENTS

FIG. 1 is a schematic diagram showing the configuration of principal parts of a die cast machine 1 according to an embodiment of the present invention. In FIG. 1, an upper part and a lower part on the paper correspond to an upper part and a lower part in a vertical direction, and a left-right direction on the paper correspond to a horizontal direction.

The die cast machine 1, for example, has a mold clamping device 3 which clamps a fixed mold 101 and a moving mold 103, an injection apparatus 5 which injects a molten metal (metal material in molten state) into a cavity 105 (see FIG. 5) formed by the clamped fixed mold 101 and moving mold 103, a not shown extrusion device which extrudes a die cast article (molded article) formed by solidification of the molten metal in the cavity 105 from the moving mold 103 or fixed mold 101, a spray device 7 for spraying a mold releasing agent and/or blowing air to the fixed mold 101 and moving mold 103 before injection, and a control device 9 for controlling these devices.

The mold clamping device 3, for example, has a base 11, a fixed die plate 13 which is fixed on the base 11 and holds the fixed mold 101, a movable die plate 15 which is provided so that it can move in the mold opening-closing direction (left-right direction on the paper) on the base 11 and holds the moving mold 103, and a plurality of (generally four) tie bars 17 which bridge the fixed die plate 13 and the movable die plate 15.

By movement of the movable die plate 15 in the mold opening-closing direction, the fixed mold 101 and moving mold 103 are closed or opened. Further, in a state where single end sides of the plurality of tie bars 17 are engaged with either the fixed die plate 13 or movable die plate 15 (movable die plate 15 in the present embodiment), the other end sides of the plurality of tie bars 17 are pulled with respect to the other of the fixed die plate 13 and the movable die plate 15 (fixed die plate 13 in the present embodiment), whereby the fixed mold 101 and moving mold 103 are clamped.

The mold clamping device 3 is for example configured by a so-called compound mold clamping device which opens and closes the mold by electric power and clamps the mold by liquid pressure (hydraulic pressure) drive. Specifically, for example, this is as follows.

The mold clamping device (mold opening and closing device) 3, for example, has a die plate driving device 19 which drives the movable die plate 15 for mainly opening and closing the mold. Further, the mold clamping device 3, for example, for mainly mold clamping, has a plurality of mold clamping cylinders 21 which drive the plurality of tie bars 17 and has a plurality of half nuts 23 which are engaged with the plurality of tie bars 17.

The die plate driving device 19, for example, has a rotary electric motor 25 and a screw mechanism 27 which transforms rotation of the electric motor 25 to translational motion. The screw mechanism 27, for example, has a screw shaft 29 which is supported by the base 11 and extends in the mold opening-closing direction and a nut 31 which is screwed with the screw shaft 29 and is fixed to the movable die plate 15. The screw shaft 29 is restricted in movement in an axial direction, and the nut 31 is restricted in rotation around the shaft.

When the rotation of the electric motor 25 is transmitted to the screw shaft 29 and the screw shaft 29 rotates around its axis, the nut 31 moves in the mold opening-closing direction. Due to this, the movable die plate 15 moves in the mold opening-closing direction. The movable die plate 15 is driven by the die plate driving device 19 between for example a mold open limit shown in FIG. 1 and a mold closed position (see FIG. 5) at which the fixed mold 101 and the moving mold 103 contact or approach.

Each mold clamping cylinder 21, for example, has a cylinder portion 33 which is provided in the fixed die plate 13 and a piston 35 which is fixed to one end of a tie bar 17 and is accommodated in the cylinder portion 33. The piston 35 partitions the interior of the cylinder portion 33 into a cylinder chamber on the front surface side of the fixed die plate 13 (on the movable die plate 15 side) and a cylinder chamber on the side opposite to the former. By selectively feeding a working fluid (for example oil) into the two cylinder chambers, the piston 35 moves in the mold opening-closing direction.

Each half nut 23 is supported by the movable die plate 15 so that it cannot move in the mold opening-closing direction with respect to the movable die plate 15. On the other hand, in the end part of the tie bar 17 on the movable die plate 15 side, an engagement portion 17a which can mesh with the half nut 23 is formed.

By feed of working fluid to the mold clamping cylinders 21 so that the pistons 35 move to the back surface side of the fixed die plate 13 in a state where the half nuts 23 mesh with the engagement portions 17a (see FIG. 5), the tie bars 17 are extended. Due to this, the fixed mold 101 and moving mold 103 are clamped.

The injection apparatus 5, for example, has a sleeve 37 which is communicated with the cavity 105, a plunger 39 capable of sliding in the sleeve 37, and a not shown plunger driving device which can drive the plunger 39. By the drive of the plunger 39 to move forward to the cavity 105 side in a state where the molten metal is supplied to the sleeve 37, the molten metal in the sleeve 37 is injected and filled into the cavity 105.

The spray device 7, for example, has a spray head 41 which ejects at least either of atomized mold releasing agent or air, a feed device 43 which feeds at least one of the mold releasing agent or air to the spray head 41, and a head driving device 45 which makes the spray head 41 enter into or retract from the space between the molds.

The spray head 41, for example, has a head base 47, a holder 49 which is attached to and detached from the head base 47, and a plurality of nozzles 51 attached to the holder 49.

The head base 47 is driven in the advance-retraction direction with respect to a space between the molds by the head driving device 45. This advance-retraction direction is for example a direction perpendicular to the mold opening-closing direction. More specifically, this is for example an up-down direction. In the head base 47, a passage for the mold releasing agent and a passage for air are formed. These passages are fed with the mold releasing agent and air from the feed device 43.

The holder 49 is configured so that it can be attached to and detached from the head base 47 by a suitable attachment mechanism. Further, in the holder 49, a passage for the mold releasing agent and a passage for air which are communicated with the passage for the mold releasing agent and the passage for air in the head base 47 are formed.

The nozzles 51 are for example formed by pipes (for example copper pipes) which can be plastically deformed and are attached to the holder 49. The attachment portion may be configured so that the nozzles 51 can be replaced at the holder 49 as well. The nozzles 51 are communicated with the passage for the mold releasing agent and the passage for air in the holder 49. By being bent, the front ends (exhaust ports) of the nozzles 51 can be suitably positioned and directed.

When the mold releasing agent and compressed air are supplied from the feed device 43 to the head base 47, they are mixed in the holder 49 and/or nozzles 51 and atomized mold releasing agent is ejected from the nozzles 51. Note that, the holder 49 may be provided with a valve for adjusting the amount of the mold releasing agent for each of the nozzles 51 as well. Further, when only air is supplied from the feed device 43, only air is ejected from the nozzles 51. This air is utilized for removing moisture of the mold releasing agent.

The feed device 43, for example, has a tank 53 which holds the mold releasing agent, a mold releasing agent compressor 55 which sends air into the tank 53 to pressurize the mold releasing agent in the tank 53 and send it out, and a mold releasing agent valve 57 which allows or blocks flow of the sent mold releasing agent to the head base 47. Spraying and stopping of spraying of the mold releasing agent from the nozzles 51 are for example controlled by opening and closing of the mold releasing agent valve 57. Note that, the mold releasing agent valve 57 may be provided at the head base 47 as well.

Further, the feed device 43, for example, has an air compressor 59 which sends out air and an air valve 61 which allows or blocks flow of the sent air to the head base 47. Ejection and stopping of ejection of air from the nozzles 51 are for example controlled by opening and closing of the air valve 61. Note that, the air valve 61 may be provided at the head base 47 as well.

The head driving device 45, for example, has a movable portion 63 which is fixed to the head base 47 and a fixed portion 65 which drives the movable portion 63 in the up-down direction. The movable portion 63 is for example configured so as to extend in the advance-retraction direction of the head base 47, that is, up-down direction. The fixed portion 65, for example, has a not shown rotary electric motor and a not shown screw mechanism which transforms rotation of this electric motor to translational motion and moves the movable portion 63 in the up-down direction. Due to this, the spray head 41 enters to or retracts from the space between the molds.

The fixed portion 65 is for example basically provided in a fixed manner. For example, the fixed portion 65 is supported upon the fixed die plate 13. Accordingly, when the movable die plate 15 moves in the mold opening-closing direction, the spray head 41 which is supported upon the head driving device 45 and the moving mold 103 which is held by the movable die plate 15 relatively move in the mold opening-closing direction.

Note that, the fixed portion 65 is for example supported by a position adjustment mechanism 67 so that the position in the mold opening-closing direction can be adjusted. The position adjustment mechanism 67 may adjust the position of the fixed portion 65 by manual operation (manpower) or may include an electric motor or another driving source and adjust the position of the fixed portion 65 according to control of the control device 9 based on an input operation etc. by an operator.

The mold releasing agent used in the spray device 7 may be oil-based or water soluble.

The control device 9, for example, although not particularly illustrated, includes a CPU, ROM, RAM, and external memory. Note that, in FIG. 1, for convenience, the control device 9 is indicated by one block. In actuality, however, the control device 9 may be configured by a combination of control units provided in various types of devices as well. The control device 9 outputs control signals for controlling the different portions based on various types of input signals which are input.

The control device 9 receives signals from for example an input device 69 which receives input operations by an operator, an encoder 71 which detects rotation of the electric motor 25, and a not shown encoder which detects rotation of a not shown electric motor included in the head driving device 45. The control device 9 outputs signals to for example a display unit 73 which displays information to the operator, an electric motor 25, and a not shown electric motor included in the head driving device 45.

The control device 9 for example performs feedback control of the position and speed of the movable die plate 15 based on a detection value from the encoder 71. Note that, FIG. 1 exemplifies a case where so-called semi-closed loop control is carried out. However, a position sensor which directly detects the position of the movable die plate 15 may be provided and (full-) closed loop control may be carried out as well.

Further, for example, based on the detection value from a not shown encoder of the head driving device 45, the control device 9 performs feedback control of the position and speed of the spray head 41. Note that, for this control as well, not semi-closed loop control, but (full-) closed loop control may be carried out as well.

FIG. 2 is a flow chart showing a procedure of a portion of a molding cycle of the die cast machine 1. Further, FIG. 3 to FIG. 5 are schematic diagrams the same as FIG. 1 showing states of the die cast machine 1 at various points of time in the molding cycle.

Before the start of step ST1, the die cast machine 1 is rendered a state as shown in FIG. 1. For example, the movable die plate 15 is positioned at the mold open limit. The spray head 41 is positioned at a position retracted from the space between the molds.

At step ST1, the control device 9 drives the head driving device 45 to make the spray head 41 enter into the space between the molds. When the spray head 41 descends to a predetermined position, the control device 9 proceeds to step ST2.

At step ST2, the control device 9 drives the die plate driving device 19 to make the movable die plate 15 move in the mold closing direction (move forward).

At step ST3, the control device 9 judges whether the movable die plate 15 has reached a predetermined spray start position. When judging that it has not reached it, the control device 9 continues the movement of the movable die plate 15 to the mold closing direction, while when judging that it has reached it, the control device 9 proceeds to steps ST4 and ST5.

According to steps ST1 to ST3 described above, as shown in FIG. 3, the spray head 41 is positioned between the molds. Further, it is positioning at a suitable distance from the moving mold 103. Note that, the distance of the spray head 41 relative to the fixed mold 101 is made a suitable extent by adjustment of the position of the spray head 41 in the mold opening-closing direction by the position adjustment mechanism 67.

At step ST4, the control device 9 opens the mold releasing agent valve 57 and air valve 61 to makes the nozzles 51 eject the atomized mold releasing agent (spray process). Due to this, the mold releasing agent is coated on the inner surfaces of the fixed mold 101 and moving mold 103.

Parallel to step ST4, at step ST5, the control device 9 drives the die plate driving device 19 to move the movable die plate 15 in the mold opening direction and/or mold closing direction (movement process). Accordingly, the mold releasing agent is sprayed to the moving mold 103 while changing the distance between the nozzles 51 and the moving mold 103. Note that, this movement is for example carried out within a relatively narrow range relative to a movable range of the movable die plate 15 (mold open limit to mold closed position). For example, the distance of this movement is no more than the difference of relief shapes of the inner surfaces of the moving mold 103.

Next, at step ST6, the control device 9 closes the mold releasing agent valve 57 to makes the nozzles 51 eject air (air blowing process). Due to this, moisture of the mold releasing agent is removed by blowing it off or evaporating it.

Parallel to step ST6, at step ST7, the control device 9 drives the die plate driving device 19 to move the movable die plate 15 in the mold opening direction and/or mold closing direction (movement process). Accordingly, air is blown to the moving mold 103 while changing the distance between the nozzles 51 and the moving mold 103. Note that, in the same way as step ST5, this movement is carried out within a relatively narrow range relative to the movable range of the movable die plate 15. As an example, it is carried out within a range no more than the difference of relief shapes of the inner surfaces of the moving mold 103.

The control device 9, for example, moves the movable die plate 15 within a relatively narrow range relative to the movable range of the movable die plate 15 through step ST5 and step ST7. Accordingly, at the time of completion of step ST7, the state of the die cast machine 1 is roughly the same as the state in FIG. 3 before the start of step ST5. That is, the movable die plate 15 is positioned more to the mold closing direction side than the mold open limit.

Next, at step ST8, the control device 9 drives the head driving device 45 to make the spray head 41 retract from the space between the molds.

When step ST8 is completed, as shown in FIG. 4, the spray head 41 is retracted from the space between the molds. Further, as already explained, the moving mold 103 is positioned more in the mold closing direction than the mold open limit.

Next, at step ST9, the control device 9 drives the die plate driving device 19 to move the movable die plate 15 in the mold closing direction. At this time, the control device 9 does not make the movable die plate 15 retract to the mold open limit. For example, it moves the movable die plate 15 in the mold closing direction from the position at the time of completion of step ST7.

After that, for example, when the moving mold 103 contacts the fixed mold 101 and the mold closing is completed, the control device 9 drives the mold clamping cylinders 21 and adjusts the meshing positions of the engagement portions 17a and the half nuts 23, then closes the half nuts 23 and makes the engagement portions 17a and the half nuts 23 mesh with each other. FIG. 5 shows the state where the half nuts 23 are closed.

Then, although particularly not shown, the control device 9 clamps the mold by driving the mold clamping cylinders 21. After the completion of the mold clamping, it drives the injection apparatus 5 to inject and fill the molten metal into the cavity 105. When the molten metal solidifies, the control device 9 releases the pressure from the mold clamping cylinders 21 and ends the mold clamping, opens the half nuts 23 to release meshing of the engagement portions 17a and the half nuts 23, and drives the die plate driving device 19 to retract the movable die plate 15 to the mold open limit (FIG. 1). After that, the die cast article in the cavity 105 is taken out by a not shown extrusion device. Then, the routine returns to step ST1.

FIG. 6A is a schematic diagram showing an example of relative movement (step ST5) of the nozzles 51 and the moving mold 103 during the spray process. Note that, in this diagram, the left-right direction on the paper is the mold opening-closing direction.

The surface of the moving mold 103 configuring the cavity 105 has for example relief shapes and in turn has surfaces 103s that follow along the mold opening-closing direction. Such surfaces 103s differ in distance and orientation with respect to the tip ends of the nozzles 51 according to the position in the surface 103s, therefore it is difficult to evenly coat the mold releasing agent over the entire area of the surfaces 103s. For example, in the state indicated by solid lines in FIG. 6A, the back side of the surfaces 103s (left side on the paper) is harder to reach by the mold releasing agent in comparison with the front side of the surfaces 103s (right side on the paper). Therefore, the mold releasing agent becomes insufficient on the back side or the mold releasing agent becomes excessive on the front side.

However, as indicated by an arrow y1 and imaginary lines (two-dot chain lines), when the movable die plate 15 is moved in the mold opening-closing direction during the spray process (steps ST4 and ST5), the tip ends of the nozzles 51 approach and/or separate from or enter and/or retract the concave portion (base of the convex portion from another viewpoint) of the moving mold 103. Accordingly, the tip ends of the nozzles 51 can approach not only positions on the front side of the surfaces 103s, but also positions on the back side of the surfaces 103s. As a result, even coating of the mold releasing agent with respect to the surfaces 103s is facilitated.

FIG. 6B is a schematic diagram showing another example of the relative movement (step ST5) of the nozzles 51 and the moving mold 103 during the spray process.

In this example, as indicated by the arrows y2 to y4 and imaginary lines (two-dot chain lines), during the spray process, not only movement of the movable die plate 15 in the mold opening-closing direction, but also movement of the nozzles 51 in the advance-retraction direction (up-down direction) are carried out. Specifically, for example, the movement of the moving mold 103 indicated by the arrow y2, movement of the nozzles 51 indicated by the arrow y3, and movement of the moving mold 103 indicated by the arrow y4 are carried out in that order. In this way, by combining the movement in the advance-retraction direction of the nozzles 51 as well, it becomes possible to suitably coat the mold releasing agent on more complex die shapes.

The relative movement of the nozzles 51 and the moving mold 103 during the spray process was explained, but the same operations as those in FIG. 6A and FIG. 6B may also be carried out for the relative movement during the air blowing process (step ST7). Due to this, it is made easier for air to reach even the positions which are hard for the air is reach due to the shape of the mold.

Note that, the relative movement of the moving mold 103 and the spray head 41 during the spray process and the relative movement of the moving mold 103 and the spray head 41 during the air blowing process may be the same in their route and/or speed etc. or may be different from each other.

Further, at step ST5 and step ST7, the relative movement of the moving mold 103 and the spray head 41 may be made reciprocating motion on a predetermined route. For example, the movable die plate 15 may be moved in a reciprocating manner. Further, the spray head 41 may be moved in a reciprocating manner interlocked with reciprocating motion of the movable die plate 15.

FIG. 7A is a schematic diagram showing an example of timings of spraying during the spray process (step ST4) and the movement of the moving mold 103.

In this diagram, an abscissa shows the time. In “SPRAY”, “ON” indicates the state where an atomized mold releasing agent is ejected from the nozzles 51, and “OFF” indicates a state where the atomized mold releasing agent is not ejected from the nozzles 51 (state where a mold releasing agent are not ejected or mold releasing agent and air are not ejected). In “MOVEMENT”, “STOP”, “ADVANCE”, and “RETRACT” indicate the stopping of the movable die plate 15, movement to the mold closing direction, and movement to the mold opening direction.

In the example of this diagram, regarding the time period when the atomized mold releasing agent is ejected from the nozzles 51 and the time period when the movable die plate 15 is driven, a part or all of one time period and a part or all of the other time period overlap each other. That is, the die cast machine 1 moves the movable die plate 15 in the mold opening-closing direction while ejecting the atomized mold releasing agent from the nozzles 51.

Note that, more specifically, in this example, all parts of the two time periods overlap each other. Further, in the time period when the atomized mold releasing agent is ejected from the nozzles 51, the movable die plate 15 is moved in a reciprocating manner one or more times.

FIG. 7B is a schematic diagram the same as FIG. 7A showing another example of timings of spraying and the movement of the moving mold 103 during the spray process (step ST4).

In this example, the time period when the atomized mold releasing agent is ejected from the nozzles 51 and the time period when the movable die plate 15 is driven do not overlap each other. That is, in the spray process, the atomized mold releasing agent is intermittently ejected from the nozzles 51, and the movable die plate 15 is moved to the mold opening-closing direction in the intervals of that ejecting. From another viewpoint, the movable die plate 15 is positioned at a plurality of positions, and the atomized mold releasing agent is ejected whenever that positioning is carried out.

According to such an operation as well, compared with a case where the atomized mold releasing agent is ejected only at one relative position of the moving mold 103 and the spray head 41 (for example, a case where step ST5 is not carried out, and the atomized mold releasing agent is ejected only at the position at step ST3), the mold releasing agent can be evenly coated.

Note that, as understood from the example in FIG. 7B, in the present embodiment, the spray process means the process from the start of ejecting of the mold releasing agent to the completion of ejecting of the mold releasing agent in each molding cycle. Accordingly, when it is stated that the movable die plate 15 is moved during the spray process, not only an embodiment of moving the movable die plate 15 while ejecting the mold releasing agent as in the example of FIG. 7A, but also an embodiment of moving the movable die plate 15 in the intervals of ejecting of the mold releasing agent as in the example of FIG. 7B are included.

Conversely, the movement of the movable die plate 15 during the spray process includes neither the movement before the first ejecting of the mold releasing agent in each molding cycle nor the movement after the last ejecting of mold releasing agent in each molding cycle.

For example, the movement at step ST2 is not included in the movement during the spray process although it is movement for spraying. Further, for example, in Patent Literature 2, after jetting the mold releasing agent, the movable die plate is moved to the mold open limit, then the mold closing step is started. However, this movement of the movable die plate to the mold open limit is not included in the movement during the spray process. Further, in the example of FIG. 7B, “RETRACT” immediately after the spray process is for preventing the spray head 41 which is retracted from the space between the molds from contacting the moving mold 103 and is the movement caused by the ejecting of the mold releasing agent. However, in the present embodiment, it is not included in the movement during the spray process.

While the movement of the moving mold 103 during the spray process was explained, in the same way, the movement of the spray head 41 during the spray process includes both of the movement in the middle of ejecting of the mold releasing agent and the movement in the intervals of the ejecting in a case where the mold releasing agent is ejecting two or more times in each molding cycle.

Further, while the movement during the spray process was explained, in the same way, the movement of the movable die plate 15 or spray head 41 during the air blowing process includes both of the movement in the middle of ejecting of air and the movement in the intervals of the ejecting in the case where air is ejected two or more times in each molding cycle.

The information defining the operation explained above may be suitably set by the manufacturer or operator of the die cast machine 1.

For example, regarding the spray start position of the movable die plate 15 at step ST3, the die cast machine 1 may receive the input of the position of the movable die plate 15 by the operator through the input device 69. Further, for example, the die cast machine 1 may receive the input of the spraying distance by the operator through the input device 69 and determine the spray start position of the movable die plate 15 based on the thickness of the mold and the position of the spray head 41 in the mold opening-closing direction which are input in advance. Further, for example, the spray start position may be set by the manufacturer to the position where the spray head 41 does not contact the mold even when the mold has the largest thickness.

Further, for example, as parameters defining the operation of the movable die plate 15 at step ST5 or ST7, for example, there can be mentioned the movement distance, movement speed, and operation pattern of the movable die plate 15. For example, the control device 9 moves the movable die plate 15 to the mold closing direction from the position which becomes the standard (for example the position at step ST3) by the set movement distance and movement speed. Further, if the reciprocating motion and the number of times are set as the operation patterns, the control device 9 moves the movable die plate 15 in a reciprocating manner by the set movement distance and movement speed. The control device 9, for example, may receive the input of information of the operator through the input device 69 with respect to at least one of the movement distance, movement speed, and operation patterns.

Note that, the input of positions at two points before and after the movement of the movable die plate 15 is equivalent to the input of the movement distance. Further, the input of the movement distance and movement time is equivalent to the input of the movement speed. The operation patterns may be input by selection from among a plurality of operation patterns prepared by the manufacturer or by input of a plurality of positions in an order of passing the movable die plate 15.

While the information defining the movements of the movable die plate 15 during the spray process and during the air blowing process was explained, in the same way, the movement distance, movement speed, operation pattern, etc. may be input through the input device 69 for the information defining the movements of the spray head 41 during the spray process and during the air blowing process.

As described above, the die cast machine 1 in the present embodiment has the mold clamping device 3, spray device 7, and the control device 9 which controls the mold clamping device 3 and spray device 7 so as to make the movable die plate 15 move in the mold opening-closing direction (step ST5) during the spray process (step ST4) of ejecting the atomized mold releasing agent from the spray head 41.

From another viewpoint, the die cast machine 1 in the present embodiment has the mold clamping device 3, spray device 7, and the input device (69) which receives the input of any one among the movement distance, movement speed, and operation pattern of the movable die plate 15 in the mold opening-closing direction during the spray process (step ST4) of ejecting the atomized mold releasing agent from the nozzles 51.

From still another viewpoint, the molding method of the present embodiment has a spray process (step ST4) of ejecting the atomized mold releasing agent from the spray head 41 positioned between the fixed mold 101 and the moving mold 103 and the movement step (step ST5) of moving the movable die plate 5 holding the moving mold 103 in the mold opening-closing direction.

Accordingly, as explained with reference to FIG. 6, the distance between the spray head 41 and the moving mold 103 can be made to change during the spray process and the mold releasing agent can be coated with a suitable distance and/or orientation with respect to the shape of the mold (relief shapes) of the moving mold 103. The die plate driving device 19 for opening and closing the mold is utilized for the relative movement of that spray head 41 and the moving mold 103, therefore it is not necessary to provide a robot arm or the like having a large degree of freedom of movement, so the configuration of the die cast machine 1 can be simplified. From another viewpoint, by just newly redesigning or newly designing the control system (control method) installed in the control device (including the input device according to need) in a known die cast machine, the mold releasing agent can be suitably coated. Application with respect to existing die cast machines is easy as well.

Further, as a result of facilitating coating of the mold releasing agent neither too much nor too little in this way, reduction of the ejected amount of the mold releasing agent can be expected. As a result, reduction of the influence of the mold releasing agent upon the environment can be expected. Further, shortening of the ejecting time of the mold releasing agent can be expected as well. As a result, shortening of the cycle time can be expected.

Further, in the present embodiment, the control device 9 controls the mold clamping device 3 and spray device 7 so as to make the movable die plate 15 move in the mold opening-closing direction while ejecting the atomized mold releasing agent from the spray head 41 (FIG. 7A).

In this case, for example, the relative position of the spray head 41 and the moving mold 103 when coating the mold releasing agent is continuously changed, therefore, uniform coating of the mold releasing agent is facilitated. Further, for example, coating of the mold releasing agent and the relative movement of the spray head 41 and the moving mold 103 are simultaneously carried out, therefore the spraying time is shortened.

Further, in the present embodiment, the control device 9 controls the mold clamping device 3 and the spray device 7 so as to make the movable die plate 15 move in a reciprocating manner in the mold opening-closing direction during the spray process (FIG. 6A, FIG. 7A, etc.).

In this case, for example, in one series of operations of making the tip ends of the nozzles 51 enter into the concave portion of the moving mold 103 and then making the tip ends of the nozzles 51 retract from the concave portion to prepare for retraction of the nozzles 51 from the space between the molds (elevation of the nozzles 51), the mold releasing agent can be coated on the front side and the back side of the concave portion of the moving mold 103, therefore it is efficient. Further, by coating the mold releasing agent over both of a forward route and backward route and/or in reciprocating motion two or more times, uneven coating of the mold releasing agent can be reduced, and evaporation of moisture of the mold releasing agent can be facilitated by coating the mold releasing agent little by little.

Further, in the present embodiment, the control device 9 controls the mold clamping device 3 and spray device 7 so as to move the spray head 41 which is positioned between the molds during the spray process in the advance-retraction direction with respect to the space between the molds (up-down direction).

Accordingly, for example, as explained with reference to FIG. 6B, even coating of the mold releasing agent with respect to more complex die shapes also is facilitated. Further, one nozzle 51 can be applied to a plurality of positions in the up-down direction of the mold, therefore also a decrease of the number of nozzles 51 is facilitated.

Further, in the present embodiment, the control device 9 controls the mold clamping device 3 and spray device 7 so as to make the movable die plate 15 (step ST7) move during the air blowing process (step ST6) of ejecting air from the spray head 41.

Accordingly, for example, it becomes easy to make air reach positions which are hard for air to reach. As a result, for example, residual moisture of the mold releasing agent in the moving mold 103 can be reduced, consequently the frequency of occurrence of defective products can be reduced. Further, from another viewpoint, moisture of the mold releasing agent can be efficiently removed.

Further, in the present embodiment, during the air blowing process, in the same way as that in the spray process, the control device 9 controls the mold clamping device 3 and spray device 7 so as to make the movable die plate 15 move while ejecting air from the spray head 41, make the movable die plate 15 move in a reciprocating manner in the mold opening-closing direction during the air blowing process, and make the spray head 41 move in the advance-retraction direction with respect to the space between the molds (up-down direction) during the air blowing process. Accordingly, effects such as efficient removal of moisture and decrease of the number of nozzles 51 are exerted.

Further, in the present embodiment, after the completion of the spray process (step ST4), the control device 9 controls the mold clamping device 3 and spray device 7 so that the movable die plate 15 is not retracted to the mold open limit, but the movable die plate 15 is advanced to thereby close the mold (step ST9).

Accordingly, by movement for making the moving mold 103 approach the spray head 41 (for example movement at step ST2), the mold closing step is started from the state where the moving mold 103 is near to the fixed mold 101. As a result, the movement distance of the movable die plate 15 in the mold closing step becomes shorter, and consequently the molding cycle is shortened.

Note that, in the embodiment described above, the spray device 7 is one example of the ejection device. The spray head 41 is one example of the eject head. The mold releasing agent and spray process (step ST4) are one example of the ejected object and ejection process. The air and air blowing process (step ST6) are other examples of the ejected object and ejection process. The mold releasing agent and air may be grasped as examples of the ejected object, and the overall process from the spray process to the air blowing process may be grasped as one example of the ejection process.

The present invention is not limited to the above embodiment and may be worked in various other ways.

The molding machine is not limited to a die cast machine. For example, the molding machine may be another metal molding machine, may be an injection molding machine molding resin, or may be a molding machine molding a material comprised of a thermoplastic resin or the like mixed with sawdust. Further, the molding machine is not limited to horizontal mold clamping and horizontal injection. For example, it may be a vertical mold clamping and vertical injection, vertical mold clamping and horizontal injection, or horizontal mold clamping and vertical injection type.

The configuration of the molding machine can be made roughly the same configuration as that of the known molding machine except the portion concerned with the control for moving the movable die plate and spray head during the ejection process (for example during the spray process and/or air blowing process), that is, except the control device (input device according to need). As apparent from this fact, the configuration of the molding machine is not limited to he one exemplified in the embodiment, but may be various known configurations.

For example, the mold clamping device is not limited to a compound mold clamping device of a combination of electric and hydraulic systems and may be all electric mold clamping device or all hydraulic mold clamping device. Note, from the viewpoint of driving the movable die plate with a high accuracy during the ejection process, the mold clamping device preferably includes an electric motor (the mold clamping device is preferably compound mold clamping device or all electric mold clamping device).

In the case where the mold clamping device includes an electric motor, the electric motor is not limited to a rotary type and may be a linear motor as well. Further, the mechanism for transforming rotation of a rotary electric motor to translational motion is not limited to a screw mechanism and may be for example a rack and pinion mechanism or a link mechanism as well.

Further, for example, the mold clamping device is not limited to a two-platen type and may be one including a toggle mechanism as well. Further, for example, the mold clamping device is not limited to a device in which a mold opening and closing driving device and a mold clamping driving device are separately provided, but may be one in which one driving device is utilized for opening and closing of the mold and mold clamping as well. Further, in the case where the mold opening and closing driving device and the mold clamping driving device are separately provided, the die plate driving device which drives the movable die plate during the spray process may be the mold clamping driving device as well.

Further, for example, the eject head (for example spray head) is not limited to one having a relatively long pipe-shaped nozzle. For example, the eject head may be one having a plate facing the inner surface of the mold when entering into the space between the molds and a relatively short nozzle attached to the plate in a suitable orientation as well. As the attachment mechanism in the eject head as well, various known mechanisms may be employed.

Further, for example, the head driving device is not limited to an electric one. For example, the head driving device may be hydraulic. Note, in the ejection process, from the viewpoint of driving the eject head with a high precision in the advance-retraction direction with respect to the space between the molds, the head driving device preferably includes an electric motor. In the case where the head driving device includes an electric motor, the electric motor is not limited to a rotary one and the mechanism of transforming the rotation to translational motion is not limited to the screw shaft in the same way as the mold clamping device. Further, the present invention makes a robot arm having a large degree of freedom unnecessary, but the head driving device may be such robot arm as well.

In the embodiment, the eject head and head driving device were provided in a fixed manner by support upon the fixed die plate. However, the eject head and head driving device may be provided so as to be supported by the movable die plate or otherwise move together with the movable die plate. In this case, by the movement of the movable die plate, the distance between the eject head and the fixed mold can be adjusted. Further, an eject head and head driving device which are supported by the fixed die plate and eject the mold releasing agent toward the moving mold and an eject head and head driving device which are supported by the movable die plate and eject the mold releasing agent toward the fixed mold may be provided as well.

The ejected object is not limited to a mold releasing agent and/or air. For example, the ejected object may be a cleaning agent which is sprayed to the mold in order to clean the mold as well. The cleaning process of ejecting this cleaning agent may be carried out for example before the ejecting of the mold releasing agent in the molding cycle (before the spray process or as a portion of the spray process) or may be carried out one time for each of predetermined number of times of molding cycles or may be carried out outside of the molding cycle. In this way, the ejection process is not limited to one during the molding cycle and may be outside of the molding cycle as well. Further, after the spray process, the air blowing process need not be carried out. Such a mold releasing agent that makes the air blowing process unnecessary is known.

In the ejection process, the eject head need not be driven. Accordingly, the head driving device may be configured so that only the eject head is driven between the position where it is retracted from the space between the molds and the position where it enters into the space between the molds (between the forward movement limit and the backward movement limit) (the head driving device may have a configuration that the eject head cannot be positioned at any position between the forward movement limit and the backward movement limit).

In the embodiment, after the eject head was made enter into the space between the molds, the movement of the moving mold to the mold closing direction was started (steps ST1, ST2). However, in the time period when the eject head is made enter into the space between the molds and the time period when the movable die plate is advanced, unless the eject head contacts the mold, part or all of one time period may overlap part or all of the other time period. Further, either may be previously started and/or completed as well. This is true also for the time period when the eject head is retracted from the space between the molds and the time period when the movable die plate is moved forward for the mold closing step.

In the embodiment, the movement of the movable die plate from the mold open limit to the spray start position (step ST2) and the movement of the movable die plate during the spray process (step ST5) were separately explained. However, the distinction of the two movements may not be clear when paying attention to only the movement of the movable die plate, for example the ejection of the mold releasing agent (spray process) is started during the movement of the movable die plate from the mold open limit to the mold closing direction. This is true also for the movement of the movable die plate during the air blowing process (during the spray process where the air blowing is not carried out) and the movement of the movable die plate in the mold closing step (step ST9). This is the same also for another ejection process other than the spray process and air blowing process.

Further, in the same way for the movement relating to the entry of the eject head into the space between the molds and the movement of the eject head during the spray process, the ejection of the mold releasing agent is started during the movement of the eject head from the retraction position from the space between the molds to the entry direction or otherwise the distinction of the two movements may not be clear when paying attention to only the movement of the eject head. This is true also for the movement of the eject head during the air blowing process (during the spray process where the air blowing is not carried out) and the movement concerned with the retraction of the spray head. This is the same also for another ejection process other than the spray process and air blowing process.

In the embodiment, after the movable die plate was moved more to the mold closing direction than the mold open limit (step ST2), the ejection of the mold releasing agent (spray process, step ST4) was started. Further, even by the movement of the movable die plate during the spray process (and during the air blowing process), the movable die plate did not retract up to the mold open limit. However, the ejection of the mold releasing agent is started at the time when the movable die plate is positioned at the mold open limit, then the movable die plate moves forward during continuation of ejection of the mold releasing agent or otherwise the movable die plate may be positioned at the mold open limit during the spray process (or during the air blowing process). This is true also for another ejection process other than the spray process and air blowing process.

Further, in the embodiment, after the completion of the air blowing process, the movable die plate started movement from the position before the mold open limit to the mold closing direction (mold closing step), but it may start the movement to the mold closing direction after returning to the mold open limit after the completion of the air blowing process (after the completion of the spray process where the air blowing is not carried out.

Priority is claimed on Japanese application No. 2014-105171, filed on May 21, 2014, the content of which is incorporated herein by reference.

### REFERENCE SIGNS LIST

1 . . . die cast machine, 3 . . . mold clamping device (mold opening and closing device), 7 . . . spray device, 9 . . . control device, 13 . . . fixed die plate, 15 . . . movable die plate, 19 . . . die plate driving device, 41 . . . spray head, 43 . . . feed device, 45 . . . head driving device, 101 . . . fixed mold, and 103 . . . moving mold.

1. A molding apparatus comprising:
a mold opening and closing device having
a fixed die plate which holds a fixed mold,
a movable die plate which holds a moving mold, and
a die plate driving device which makes said movable die plate move in a mold opening-closing direction;
an ejection device having
a feed device which feeds an ejected object to an eject head and
a head driving device which makes said eject head advance to and retract from a space between said fixed mold and said moving mold; and
a control device which controls said ejection device and said mold opening and closing device so as to make said movable die plate move in said mold opening-closing direction during an ejection process of ejecting said ejected object from said eject head.

2. The molding apparatus as set forth in claim 1, wherein the control device controls the mold opening and closing device and the ejection device so as to make the movable die plate move in the mold opening-closing direction by the mold opening and closing device while ejecting the ejected object from the eject head by the ejection device.

3. The molding apparatus as set forth in claim 1, wherein the control device controls the mold opening and closing device so as to make the movable die plate reciprocally move in the mold opening-closing direction during the ejection process.

4. The molding apparatus as set forth in claim 1, wherein the control device controls the ejection device so as to make the eject head positioned between the molds move to the advance-retraction direction with respect to the space between the molds during the ejection process.

5. The molding apparatus as set forth in claim 1, wherein the control device controls the mold opening and closing device so as to make the movable die plate advance to close the mold without causing the movable die plate to retract to the mold opening limit after the completion of the ejection process.

6. The molding apparatus as set forth in claim 1, wherein the ejected object is a mold releasing agent.

7. The molding apparatus as set forth in claim 1, wherein the ejected object is air.

8. The molding apparatus as set forth in claim 1, wherein: the ejected object is a mold releasing agent and air, and the ejection process has a spray process of ejecting the mold releasing agent from the eject head and an air blowing process of ejecting air from the eject head after the spray process.

9. A molding apparatus comprising:
a mold opening and closing device having
a fixed die plate which holds a fixed mold,
a movable die plate which holds a moving mold, and
a die plate driving device which makes said movable die plate move in a mold opening-closing direction;
an ejection device having
a feed device which feeds an ejected object to an eject head and
a head driving device which makes said eject head advance to and retract from a space between said fixed mold and said moving mold; and
an input device which receives at least one input among a movement distance, movement speed and movement pattern which are ones of said movable die plate in said mold opening-closing direction during an ejection process of ejecting said ejected object from said eject head.

10. A molding method comprising:
an ejection process of ejecting an ejected object from an eject head which is positioned between a fixed die plate and a movable die plate and
a movement process of making said movable die plate which holds said moving mold move in a mold opening-closing direction during said ejection process.

11. The molding method as set forth in claim 10, further comprising, in the movement process, making the movable die plate move in the mold opening-closing direction while ejecting the ejected object from the eject head.

12. The molding method as set forth in claim 10, further comprising, in the movement process, making the movable die plate move in a reciprocating manner in the mold opening-closing direction during the ejection process.

13. The molding method as set forth in claim 10, further comprising, in the movement process, making the eject head which is positioned between the molds move in the advance-retraction direction with respect to the space between the molds during the ejection process.

14. The molding method as set forth in claim 10, further comprising a mold closing step of making the movable die plate advance to close the mold after the completion of the ejection process and movement process, wherein
the movable die plate is not made to retract to the mold open limit when shifting from the ejection process and the movement process to the mold closing step.

15. The molding method as set forth in claim 10, wherein the ejected object is a mold releasing agent.

16. The molding method as set forth in claim 10, wherein the ejected object is air.

17. The molding method as set forth in claim 10, wherein:
the ejected object is a mold releasing agent and air, and
the ejection process has
a spray process of ejecting the mold releasing agent from the eject head and
an air blowing process of ejecting air from the eject head after the spray process.
